(19) United States
(12) Patent Application Publication
(10) Pub. No.: US 2017/0116871 A1
(43) Pub. Date: Apr. 27, 2017

(54) SYSTEMS AND METHODS FOR AUTOMATED TAILORED METHODOLOGY-DRIVEN INSTRUCTION

(71) Applicant: Christina Castelli, Bernardsville, NJ (US)

(72) Inventor: Christina Castelli, Bernardsville, NJ (US)

(21) Appl. No.: 15/335,426

(22) Filed: Oct. 26, 2016

Related U.S. Application Data
(60) Provisional application No. 62/246,575, filed on Oct. 26, 2015.

(51) Int. Cl. G09B 5/06; G09B 7/00

(52) U.S. Cl. CPC G09B 5/065; G09B 7/00

(57) ABSTRACT

Automated systems and methods that enable students to supplement their education using computer-based algorithm diagnoses without the need for teacher involvement or interaction. The systems and methods automatically custom-assess students' needs and assemble a customized student learning path without human intervention or action. The systems and methods automatically assess the student's advancement during the lesson and adjust the lesson to correspond with the student's performance and/or the student's preferred learning style.

### CROSS-REFERENCE TO RELATED APPLICATIONS

This application claims the benefit of U.S. Provisional Application No. 62/246,575, filed Oct. 26, 2015, the entire contents of which are incorporated herein by reference.

### FIELD OF THE INVENTION

The present invention is directed to the field of educational support. Specifically, the present invention is directed to systems and methods for conducting custom-constructed skills evaluations, and providing custom-constructed curriculum plans.

### BACKGROUND OF THE INVENTION

Peer-mediated instruction is used in academic settings as a tool for encouraging students to gain confidence in peers and share knowledge with one another. Students collaborate in groups to complete projects, and in one-on-one tutoring sessions to support learning and reinforce difficult concepts. It has proven to be a highly effective technique, and students often gain motivation and perform higher academically after participating in peer-mediated learning.

However, the current systems and methods of peer-mediated instruction often require participation by an instructor. The current systems and methods also typically present lessons based solely on a student's grade level. Yet, a student may already excel at certain skills within a given subject area at grade level, while requiring assistance in other skills within the subject area at that level. A software-based method for custom-tailoring a curriculum using different learning methods from the primary learning styles for each student is needed.

Experts and data sources agree that different students learn in different ways; a learning approach that works well for one student does not necessarily work as well for another student. Each student may tend toward being a visual learner, aural learner, kinesthetic user, or read-write learner. In the typical school classroom, lessons are presented by visual teaching via a wipe board or chalkboard, and then students are provided read-write opportunities in the form of homework and/or practice within the classroom. Teachers usually do not have the capacity to tailor every skill for every subject area to directly meet both the student's skill level and also the student's preferred method of learning.

### SUMMARY OF THE INVENTION

An object of the present invention is to provide automated systems and methods that enable students to supplement their education with new lessons outside the classroom (e.g., on their personal computers or mobile devices), and to allow them to strengthen areas of weakness using computer-based algorithm diagnoses without the need for teacher involvement or interaction.

It is a further object of the present inventions to provide peer-to-peer engagement and virtual interaction, and fulfill a crucial need by offering immediately accessible peer learning through structured custom video curriculum and scaffolded, learning type-based custom instruction, all without involvement from a teacher or peer tutor.

Another object of the present invention is to automatically custom-assess students' needs and assemble a customized student learning path without any human intervention or action.

Yet another object of the present invention is to automatically assess the student's advancement during the lesson and adjust the lesson to correspond with the student's performance and/or the student's preferred learning style.

### BRIEF DESCRIPTION OF THE DRAWINGS

A further understanding of the invention can be obtained by reference to a preferred embodiment set forth in the illustrations of the accompanying drawings. Although the illustrated embodiment is merely exemplary of systems, methods, and apparati for carrying out the invention, both the organization and method of operation of the invention, in general, together with further objectives and advantages thereof, may be more easily understood by reference to the drawings and the following description. The drawings are not intended to limit the scope of this invention, which is set forth with particularity in the claims as appended hereto or as subsequently amended, but merely to clarify and exemplify the invention.

FIG. 1 is a flowchart depicting a method in accordance with the present invention;

FIG. 2 is an exemplary database table for skills;

FIG. 3 is an exemplary database table for questions and answers;

FIG. 4 is an exemplary database table for student account profiles;

FIG. 5 is an exemplary database table for student skill difficulty levels; and

FIG. 6 is an exemplary flowchart consistent with a preferred embodiment of the present invention.

### DETAILED DESCRIPTION OF THE INVENTION

The invention may be understood more readily by reference to the following detailed description of a preferred embodiment of the invention. However, techniques, systems, and operating structures in accordance with the invention may be embodied in a wide variety of forms and modes, some of which may be quite different from those in the disclosed embodiment. Consequently, the specific structural and functional details disclosed herein are merely representative, yet in that regard, they are deemed to afford the best embodiment for purposes of disclosure and to provide a basis for the claims herein, which define the scope of the invention. Also, as used in the specification and the appended claims, the singular forms “a”, “an”, and “the” include plural referents unless the context clearly indicates otherwise.

The systems and methods of the present invention may be practiced, for example, via an application on a stand-alone computer or mobile device, or via one or more servers accessible via an Internet website. Each server would include non-transitory computer memory. The inventions will be illustrated herein using the example of a website hosted on a server and one or more databases hosted on the same or separate servers. The website may be accessed using a website browser such as Microsoft's Internet Explorer, Google's Chrome, or Mozilla's Firefox. However, the inventions are not limited to any specific type of device or browser. The user of the system will be referred to herein as a student.

### Skills and Associated Instructional Material

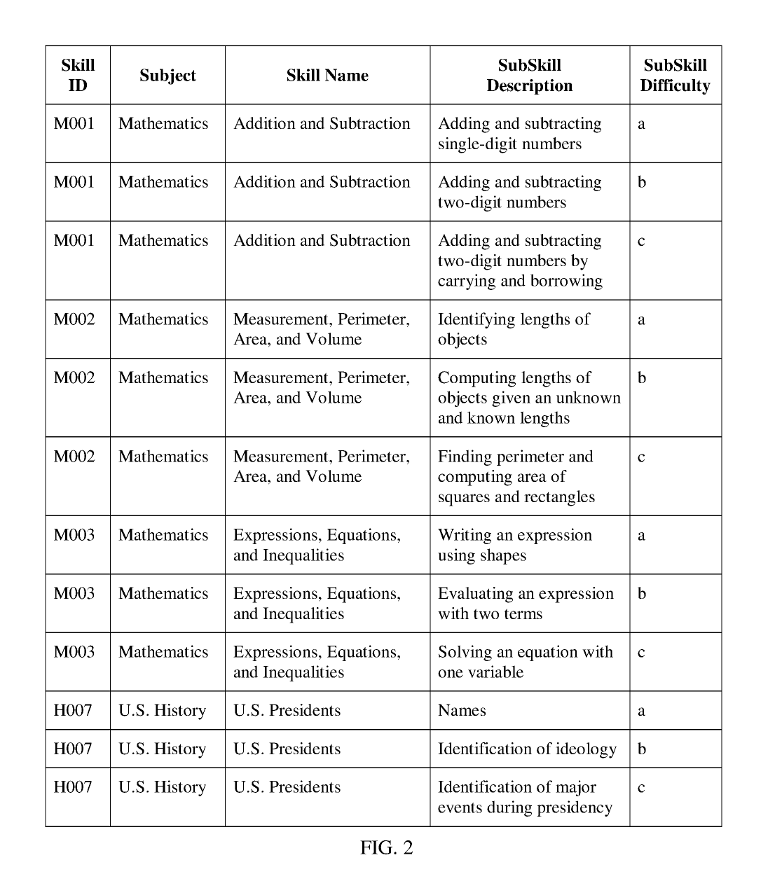

The system may store, for example in one or more SQL database tables, a variety of skill profiles and associated test questions. As shown in FIG. 2, the skill profile data structure may include a skill ID, subject name, skill name, subskill description, and subskill difficulty in corresponding database columns. Subjects may include school subjects such as mathematics, geography, or chemistry. The subskill difficulty may correspond to a grade level, government standards, or any other measure of the level of mastery of a subject. However, the system is not limited to subjects taught in schools; it may be used to provide instruction concerning any subject or topic.

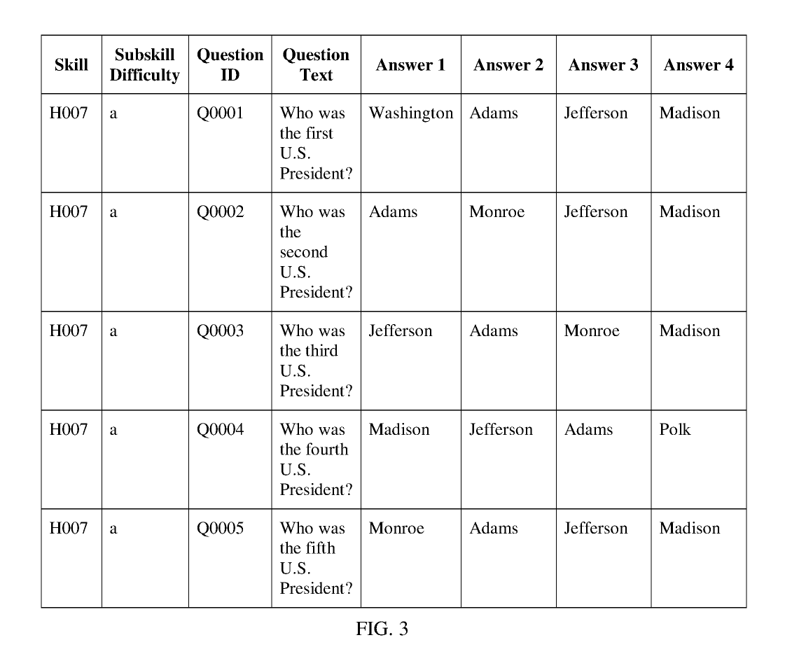

As shown in FIG. 3, a table of test questions associated with each skill profile may include columns corresponding to skill, subskill difficulty, test question ID, the question string, and up to a predetermined number of possible answers in separate database columns. For example, the table shown in FIG. 3 includes four possible answers associated with each question. In one embodiment, the correct answer for each question is stored in the first answer database column. When the questions and potential answers are presented to a student, the order of the potential answers may be randomized or presented in a predetermined order.

The system may also store one or more types of instructional materials. For example, the system may store instructional videos in the form of video files (e.g. MPEG files, WMV files), auditory instructional material in the form of audio files (e.g. MP3 files, AAC files), or text-based instructional material in the form of read-write files (e.g. DOC files, TXT files). The system may further store kinesthetic instructional material, for example in the form of Scalable Vector Graphics (SVG) files together with Cascading Style Sheets (CSS) and JavaScript (JS). The SVG file may contain the shape and geometric information of the kinesthetic instruction data to be displayed. The CSS file may contain additional styling information to affect the shape data from the SVG. The JS file may contain computer code that may dynamically update the SVG information and apply CSS properties in response to user input throughout the instructions.

The system may store the different types of instructional material separately, for example in separate folders for each file type. Alternatively, the files may be organized, for example in folders, according to skills, subskills, and/or subskill difficulty levels associated with the files. Preferably one of each type of instructional material (e.g., instructional video, auditory instructional material, or text-based instructional material, kinesthetic instructional material) would be stored by the system for each subskill difficulty level of each skill or subskill

### Student Profiles and Evaluation Information

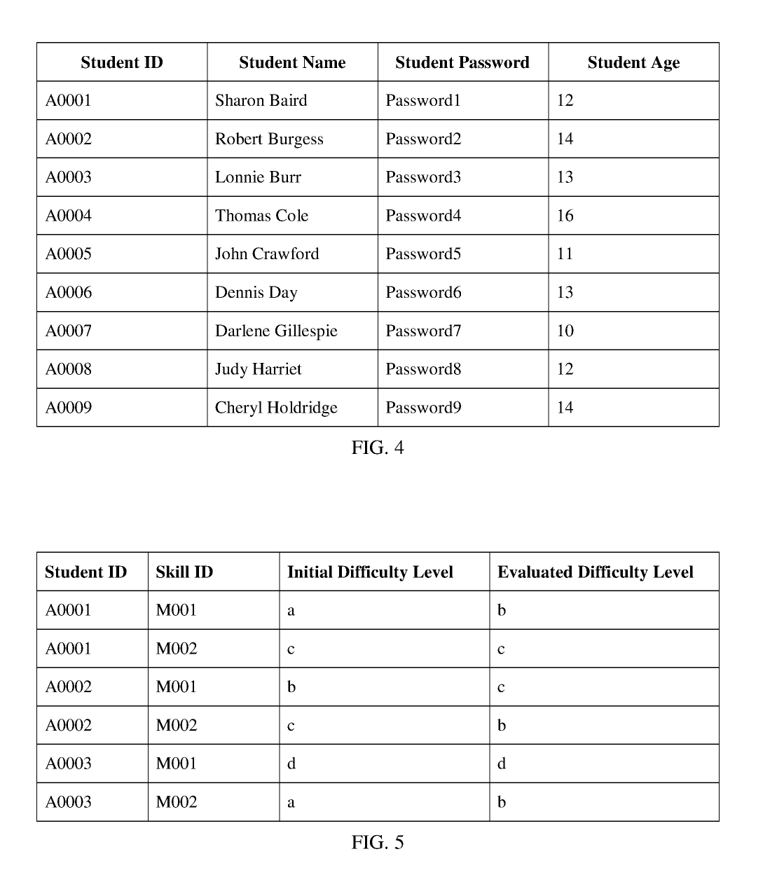

When a student accesses the system, the system may require the student to provide identifying information such as a user name, password, and/or biometric data. The system may create a student account profile in, for example, an SQL database using the information provided by the student. An example database table for student account profiles is shown in FIG. 4.

The student may also be asked to enter certain evaluation information. The evaluation information may include, for example, the student's current grade level, school district, city of residence, and recent standardized test scores. The evaluation information may be stored in an SQL database as the student's educational profile and, for example via database keys, related to the student account profile for future retrieval. In the alternative, the information could be stored in the same database used to store the student account profile. As shown in FIG. 5, in the same or a separate database, a column may be reserved to record an initial difficulty level for one or more skills or subskills corresponding to the student's grade level. The initial difficulty level for each skill or subskill, however, may be adjusted up or down based on other data in the student's educational profile, such as the student's standardized test scores. For example, if the student's standardized test scores are below a predetermined level or percentage for a particular mathematics skill, the system may adjust the student's initial difficulty level to a level lower than the level corresponding to the student's grade level alone.

The system may also receive demographic information, including information about schools throughout the country, the student's school or district, or the academic demographics nearest to or associated with the student. The system may use the demographic information to adjust the initial difficulty level assigned to one or more skills or subjects. For example, if a student is from an academic demographic that struggles with mathematics but is ahead of the national average in reading, the system may lower the initial difficulty level recorded for mathematics and raise the initial difficulty level recorded for reading. The system may also weight academic demographics and grade levels at different percentages. For example, the demographics information may factor into the initial difficulty level at a rate of 40%, and grade level may factor at 60%.

The student may also be asked to enter one or more skills or subjects for which the student is seeking instruction. In the alternative, the skills or subjects may be pre-selected for the student by, for example, the student's school teacher, parent or legal guardian, coach, employer, or supervisor.

### Generate and Administer Skills Assessment

Using the initial difficulty level recorded for each skill or subskill, the system may generate a skills assessment (also referred to as a skills questionnaire) that may be used to further evaluate the student's knowledge and level of mastery of one or more skills or subskills. To generate the skills assessment, the system may select assessment questions for each skill or subskill to be tested, based on the initial difficulty level recorded for that subject. The questions may be selected, for example, randomly, or in the sequential order in which they are stored in memory.

The questions may be denoted with difficulty levels by, for example, recording a difficulty level for each question and associating the difficulty level with the question, as shown in FIG. 3. In the alternative, the questions may be stored in an order of increasing or decreasing difficulty, and the system may choose questions based on the relative order of the questions.

The skills assessment questions may be administered to the student via a computer screen. The student may be provided with a series of questions and a number of potential answers for each question from, for example, the assessment question database table. If more than one skill is to be presented by the system, the system may intermix questions from the different skills (randomly or according to a predetermined order) when they are presented to the student.

The student may enter responses to the questions using any means of inputting data, including by typing a response on a keyboard, using a computer mouse to select one or more responses on the screen, touching one or more portions of a touch screen displaying a graphic element(s), or identifying a response by speaking into a microphone. As or after the student responds to the skills assessment questions, the system may group the assessment questions and the student's corresponding responses into skill clusters, which may be based on state and/or national standards. The student's responses may be stored in an SQL database table with, for example, answer ID, student ID key, question ID, answer selected and a Boolean database column indicating whether the answer was correct or not

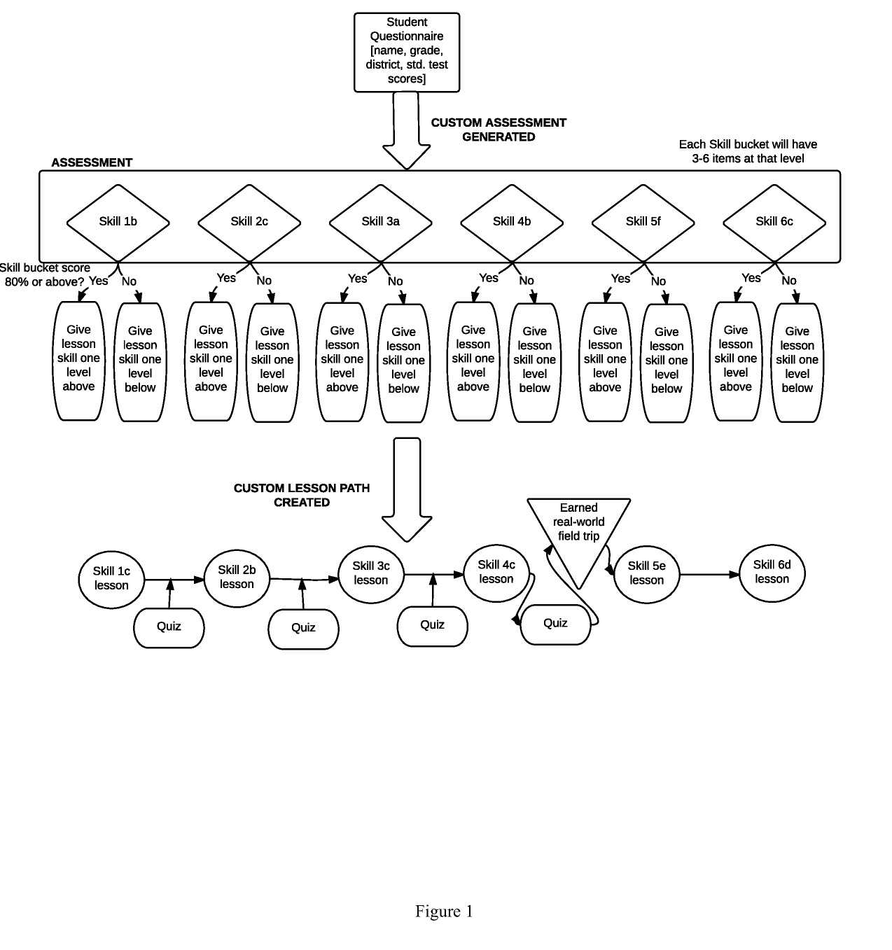

The process of administering the skills assessment is generally depicted in FIG. 1. As the student answers each question or a set questions in the skills assessment, the system may select subsequent assessment questions to present to the student based on the student's satisfactory or dissatisfactory performance on one or more prior questions. For example, a student may specify on the website that the student is currently in grade two. A particular skill set may then be tested at a difficulty level corresponding to grade two. If the student provides correct responses to the first three assessment questions, the system may present the student with subsequent questions at the difficulty level corresponding to grade three. If the student instead only answers one of the first three assessment questions correctly, the system may instead present the student with questions at the difficulty level corresponding to grade one. If the student, however, answers two out of the first three questions correctly, the system may, for example, determine that grade two is the evaluated difficulty level for that skill set for the student.

Each skill set might also include multiple “buckets” reflecting different levels of subject difficulty. For example, Skill Set 1 might focus on addition, with bucket 1(a) including the most basic standards (grade K, for example), and bucket 1(w) including the most advanced topics (e.g., grade 9 standards, etc.). Each bucket may be correlated with sets of standards, such as Common Core and individual state standards. FIG. 1 depicts exemplary “skill buckets” created in a lesson plan for a student who does not demonstrate all skills at the same grade level. For Skill 1, the student is shown at bucket 1(c), and for Skill 2, the student is at bucket 2(b). In that way, the lesson plan is custom tailored to the student's abilities based on his assessment results rather than solely based on a grade level's entire skill set.

The assessment may continue until questions for all of the skills have been presented to the student and evaluated difficulty levels have been determined for each skill and/or subskill to be tested. The evaluated difficulty level may be the same or different than the initial difficulty level. As shown in FIG. 5, the evaluated difficulty level may be recorded in the same database as the initial difficulty level. In the alternative, the evaluated difficulty level may be stored in a separate database, such as an SQL database table having a structure of unique ID, student ID key, skill ID key and evaluated difficulty level columns for future retrieval.

### Education Phase—Tailored Methodology-Driven Instruction

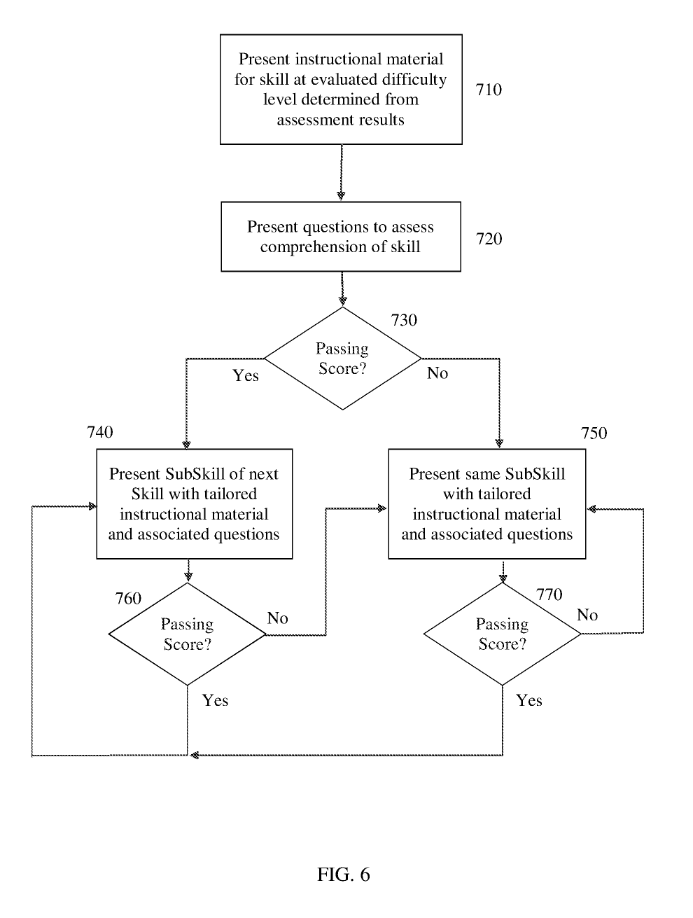

The student next enters the education phase. Instructional material may be presented to the student on a computer display screen, tablet screen, projected on a wall or screen, or by any other means of display. As shown in FIG. 6 at step 710, for each skill set, the system presents to the student instructional material preferably associated with a difficulty level corresponding to the evaluated difficulty level determined for the student in that subject or skill set. The type of instructional material presented (e.g. instructional video, auditory material, read-write material, or kinesthetic material) may be randomly selected from the types of material stored in the system. In the alternative, the first type of material to be presented to the student for each skill set may be predetermined. As a further alternative, the system may present one of each type of instructional material for each skill set according to a predetermined order of material types (e.g. video then audio then read-write then kinesthetic, etc.). In a preferred embodiment, the first type of instructional material to be presented to the student for all skill sets is an instructional video, and the instructional video preferably includes peer-video instruction.

At Step 720, after a predetermined time or, in the alternative, when the student enters a command indicating that the instructional material presentation has completed, the system may present to the student a first set of test questions to determine the extent to which the student understood and learned the instructional material. At Step 730, the system may determine whether the student achieved a passing score by, for example, answering a predetermined number or percentage of the first set of test questions correctly. In the alternative, the system may evaluate the student's responses by the number or percentage of the first set of test questions answered incorrectly.

If at Step 730 the system determines that the student failed to achieve a passing score, at Step 750 the system may present to the student further instructional material for the same skill or subskill, at the same difficulty level. The further instructional material may be of the same type (e.g. instructional video) as the first instructional material. Preferably, however, the further instructional material is of a different type. The lesson presentation may also include associated worksheets or other material.

After the further instructional material is presented at Step 750, the system may present to the student a second set of test questions to determine the extent to which the student understood and learned the material from the presentation. Some or all of the second set of test questions may be different from the first set of test questions, or they may all be the same.

At Step 770, if the system determines that the student achieved a passing score, the system may proceed to Step 740 and instructional material at the next higher level of difficulty.is presented to the student. If the student fails to achieve a passing score at Step 770, the system may return to Step 750 to (1) present to the student further instructional material at the same level, including one of the instructional materials previously presented to the student, but preferably a different type of instructional material;, or (2) present to the student instructional material associated with the next lower difficulty level.

If at Step 730 the system determines that the student achieved a passing score, at Step 740 the system may present to the student instructional material associated with the next higher difficulty level. The order of instructional material presented may be determined, for example, by the order in which it is presented in a textbook, or based on a curriculum set by a school, employer, or other institution. The type of instructional material presented to the student at Step 740 may be randomly determined by the system. In the alternative, the first instructional material presented for each higher level skill set may be a predetermined type (e.g. instructional video) for each skill set or all skill sets.

In a preferred embodiment, the system may determine the type of instructional material to present to the student based on the student's level of correct responses to questions presented following prior presentations. For example, a student may be presented with an instructional video at Step 710. If the student achieves a passing score at Step 730, at Step 740 the system may select the same type of instructional material to present to the student. Alternatively, the system may only present the same type of material to the student at Step 740 if the student achieves a predetermined score at Step 730 (e.g. 90% of questions answered correctly). Otherwise, the system may present a different type of instructional material at Step 740.

The system may also use the student's scores from questions following each type of instructional material to determine which type of instructional material to present for each successively higher skill level. For example, the system may maintain a running average of scores achieved by the student following presentations of each type of instructional material. The system may then present to the student at Step 740 the type of instructional material corresponding to the material for which the system has recorded the highest average achieved by the student.

After presenting the instructional material at Step 740, the system may present to the student a set of test questions associated with the instructional material to determine the extent to which the student understood and learned the material. At Step 760, the system may determine whether the student achieved a passing score by, for example, answering a predetermined number or percentage of the first set of test questions correctly. If at Step 760 the system determines that the student achieved a passing score, the system may return to Step 740 and present to the student the next higher level of instructional material.

If at Step 760 the system determines that the student failed to achieve a passing score, at Step 750 the system may present to the student the same instructional material again. Alternatively, the system would present a different type of instructional material. The presentation may also include associated worksheets or other material. At Step 770, the system would proceed as indicated above.

Alternatively, if the student achieves a passing score at Step 730 or Step 740, the process may return to Step 710 and present instructional material for the next skill in the lesson plan at the evaluated difficulty level determined from the assessment results. The process would continue in that manner until all instructional material for all of the skills or subskills in the lesson plan are presented to the student.

In addition or in the alternative, questions may be presented to a student during a video presentation, instead of after the video presentation is completed—both are intended to check student comprehension of the subject of the video. The student may respond to the questions by, for example, typing in a response to a query from the video, or responding to questions on the screen. If the student responds with an incorrect answer, the video may indicate to the user that the response was incorrect and present further instruction on the subject. If the student responds with a correct answer, the video may indicate to the user that the response was correct and move forward with the lesson. The subsequent instruction may depend on the number or percentage of correct response entered by the student.

Achieving a passing score, or achieving a higher predetermined level of successful answers (e.g., answering all questions correctly) for any set of test questions may also result in the student being presented with one or more rewards, including but not limited to video associated in the backend datastore with the appropriate lessons. Each field trip video presents real-world examples of situations that use the skill sets the students have been acquiring. They would present the student with a non-classroom, real-world setting to see how things are built, decisions are made, services are run, etc. The real-world experiences are skills-linked. The system may facilitate contests in which students could vote for or suggest their preferred locations for virtual field trips.

The system may continue presenting instruction material or video presentations, presenting associated test questions, scoring the student's responses to the questions and presenting the next material until, for example, the student chooses to exit the system, or the student reaches a predetermined skill level difficulty.

Student completion of lessons and performance on any intermittent test questions is stored in the datastore for future retrieval. During or after a lesson, a report may be generated to present or record the student's status and progress. For districts or classrooms that register for the service, a teacher may view a student's progress via a report system and enable a bonus or challenge section to route certain students through a lesson of additional concepts not aligned to standards but that consist of real-world applications.

The system may also rank students based on their performance to promote peer competition. Students could take speed tests and compete against other students in the system for rankings and “virtual” prizes of some sort. The identities of the other students participating in the system may be kept anonymous.

Students may also be presented with the option to print or download a supplemental worksheet with activities the student can perform at home to apply what they have learned. The activities may constitute a home lab comprising tasks based on skills the student acquired.

While the invention has been described with reference to the preferred embodiment and alternative embodiments, which embodiments have been set forth in considerable detail for the purposes of making a complete disclosure of the invention, such embodiments are merely exemplary and are not intended to be limiting or represent an exhaustive enumeration of all aspects of the invention. The scope of the invention, therefore, shall be defined solely by the following claims. Further, it will be apparent to those of skill in the art that numerous changes may be made in such details without departing from the spirit and the principles of the invention. It should be appreciated that the invention is capable of being embodied in other forms without departing from its essential characteristics.

What is claimed is:

1. A computer implemented method for providing automated instruction comprising:
Storing in non-transitory computer memory one or more questions and two or more answers corresponding to each question, wherein each question is associated with a skill difficulty level;
Receiving user evaluation information comprising at least two of a user's grade level, school district, city of residence, and recent standardized test scores;
Calculating for the user an initial skill difficulty level for one or more skills;
Presenting on a display screen an assessment comprising a first subset of the questions and two or more answers corresponding to each question, wherein each question is associated with an initial skill difficulty level calculated for the user;
Receiving from the user responses to the questions;
Grouping responses to the questions into one or more skill set clusters;
Scoring the clusters to determine for the user an evaluated difficulty level for each of said skills;
Presenting to the user a first instructional video;
Presenting to the user a second subset of questions and two or more corresponding answers for each question;
Receiving from the user responses to second subset of questions, and
If the user responds to a predetermined number of the second subset of questions correctly presenting a second set of video instruction material, and presenting to the user a third subset of questions and two or more corresponding answers for each question;
If the user does not respond to a predetermined number of the second subset of questions correctly, presenting a different instructional material of a type different than an instructional video, and presenting to the user a fourth subset of questions and two or more corresponding answers for each question;
Receiving from the user responses to the third or fourth subset of questions and determining the next video instruction or alternate learning method instruction to present to the user based on the user's responses.
